(19) United States
(12) Patent Application Publication
(10) Pub. No.: US 2013/0219510 A1
(43) Pub. Date: Aug. 22, 2013

(54) DRM/CAS SERVICE DEVICE AND METHOD USING SECURITY CONTEXT

(71) Applicant: Samsung Electronics Co., Ltd., (US)

(72) Inventors: Sergey Nikolayevich SELEZNEV, Gyeonggi-do (KR); Byung Rae Lee, Seoul (KR); Bo-Gyeong Kang, Gyeonggi-do (KR)

(73) Assignee: Samsung Electronics Co., Ltd., Gyeonggi-do (KR)

(21) Appl. No.: 13/773,137

(22) Filed: Feb. 21, 2013

(30) Foreign Application Priority Data
Feb. 21, 2012 (KR) 10-2012-0017475

(51) Int. Cl. G06F 21/60

(52) U.S. Cl. CPC G06F 21/60
USPC 726/27

(57) ABSTRACT

A DRM/CAS service device is provided. The device includes a registration service server that authenticates a device and an STP of the device and generates a device-based context according to a registration request and a DRM/CAS service request from the device; a DRM/CAS service server that receives the device-based context and generates DRM/CAS security contexts; and a DRM/CAS SW service server that receives the DRM/CAS security contexts, generates the DRM/CAS software package including the DRM/CAS security contexts and DRM/CAS software, and enables the DRM/CAS software package to be provided for the device. The DRM/CAS service device reduces the amount of processing and simplifies the process by installing and using content and service protection software, that is, DRM/CAS software by using a security context.

### PRIORITY

This application claims priority under 35 U.S.C. §119(a) to Korean Application Serial No. 10-2012-0017475, which was filed in the Korean Intellectual Property Office on Feb. 21, 2012, the entire content of which is incorporated herein by reference.

### BACKGROUND OF THE INVENTION

1. Field of the Invention

The present invention relates generally to a DRM/CAS service apparatus and method, and specifically to a DRM/CAS service apparatus and method for providing a more safe and effective DRM (Digital Rights Management) and a CAS (Conditional Access System) service, especially using a security context.

2. Description of the Related Art

In the digital era, how digital contents and services can be safely provided to a user device, such as by television, computer, and portable devices, has become a major issue. Accordingly, in order to protect digital contents and services, content and service protection systems, such as DRM (Digital Rights Management) and a CAS (Conditional Access System) have been provided.

DRM is a technology for continuously managing and protecting rights of an intellectual property of a digital content by using an encryption technology. CAS is a technology for limiting electronic transmission of digital media, particularly, satellite television signals through cables, to registered clients. While DRM provides protection for the content for its lifetime, CAS protects content only at the time of transmission. However, both DRM and CAS are used as systems for protecting contents and services.

That is, DRM and CAS are technologies for safely transmitting various contents and services from a content provider (CP) to user devices, and enabling the contents and services to be used only by allowed user devices or customers. In order to use contents and services to which DRM and/or CAS technologies are applied, the user devices should be equipped with DRM and/or CAS functions.

Recently, a method of downloading and installing content and service protection software (DRM and/or CAS) by an on-demand scheme on a user device, and using the installed content and service protection software at the time of acquiring and consuming protected contents (for example, reproducing or outputting contents), has been developed and used.

FIG. 1 illustrates a process for downloading and installing DRM/CAS according to the conventional art. With reference to FIG. 1, a device 10 may be a user device such as a television, a computer, and a portable device. A service provider portal 20 may be a content and service provider portal providing digital contents and services for the device 10. In Step 12, the service provider portal 20 registers the device 10 for which contents and services are provided according to a request by a user (customer) and requests permission of the customer for setting the device 10 to receive digital contents and services to the device 10. At this point, when the permission of the customer has been received, the device 10 provides the permission for the service provider portal 20. As the permission of the customer has been received, the service provider portal 20 requests to download and install content and service protection software (DRM and/or CAS software) to the device 10 in Step 14. In Step 16, the device 10 communicates with a DRM/CAS software (SW) provider 30 to download the DRM/CAS software and installs the downloaded DRM/CAS software. Though it is not specifically described, the interaction between the device 10 and the DRM/CAS SW provider 30 for downloading and installing the DRM/CAS software, that is, several times of the transmission and reception of messages, may be performed.

In this manner, when the installation of the DRM/CAS software is completed, in Step 18, the device 10 communicates with a DRM/CAS server 40 and performs registration so that the DRM/CAS client by the installed DRM/CAS software is operated. At this point, the device 10 and the DRM/CAS server 40 enables the DRM/CAS client to be operated in the device 10 using the downloaded DRM/CAS software ID and device performance (for example, whether or not 2-pass protocol is supported in the case of OMA DRM), DRM/CAS-based registration information (for example, whether or not the registration is 4-pass in the case of Open Mobile Alliance (OMA) DRM), and DRM/CAS domain join information for the customer device to share the contents.

However, the method according to the conventional art has a high overhead in communication between the device 10 and the DRM/CAS server 40 in a process of downloading and installing the DRM/CAS software for operation.

In other words, the above method according to the conventional art uses functions of DRM/CAS software downloaded by the device 10 so that the DRM/CAS client can be completely available and acquires a license for contents and services by the DRM/CAS client. Therefore, the amount of processing for the method is large and the processing methods are complicated.

### SUMMARY OF THE INVENTION

The present invention has been made to address at least the problems and disadvantages described above and to provide at least the advantages described below. Accordingly, an aspect of the present invention is to provide a DRM/CAS service device and method using a security context that can reduce the amount of processing at the time of installing and using content and service protection software, that is, DRM/CAS software, and that can simplify the process.

Further, another aspect of the present invention is to provide a DRM/CAS service device and method for more easily protecting contents and services by receiving content and service protection software (DRM/CAS software) including a security context and by acquiring and processing a license for the content and service using the security context in a device equipped with a Secure Trusted Platform (STP).

In accordance with an aspect of the present invention, a DRM/CAS (Digital Rights Management/Conditional Access System) service device is provided. The DRM/CAS service device includes a registration service server that authenticates a device and a Secure Trusted Platform (STP) of the device and generates a device-based context according to a registration request and a DRM/CAS service request from the device; a DRM/CAS service server that receives the device-based context and generates DRM/CAS security contexts; and a DRM/CAS software (SW) service server that receives the DRM/CAS security contexts, generates a DRM/CAS software package including the DRM/CAS security contexts and DRM/CAS software, and enables the DRM/CAS software package to be provided for the device.

In accordance with another aspect of the present invention, a DRM/CAS (Digital Rights Management/Conditional Access System) service method is provided. The method includes authenticating a device and an STP of the device and generating a device-based context according to a registration request and a DRM/CAS service request from the device; receiving the device-based context and generating DRM/CAS security contexts; receiving the DRM/CAS security contexts and generating a DRM/CAS software package including the DRM/CAS security contexts and DRM/CAS software, and providing the DRM/CAS software package for the device.

In accordance with yet another aspect of the present invention, a device is provided, including a communication unit that communicates with servers for receiving a DRM/CAS (Digital Rights Management/Conditional Access System) service; an STP that stores software and data for the DRM/CAS service; and a controller that performs a request for the DRM/CAS service by communicating with the servers for receiving the DRM/CAS service, receives a DRM/CAS software package according to the request for the DRM/CAS service, and performs storage and installation on the STP.

In accordance with still another aspect of the present invention, a DRM/CAS (Digital Rights Management/Conditional Access System) service method in a device is provided. The DRM/CAS service method includes performing a request for the DRM/CAS service by communicating with servers for receiving the DRM/CAS service; receiving a DRM/CAS software package embedding DRM/CAS security contexts and DRM/CAS software according to the request for the DRM/CAS service; and storing and installing the DRM/CAS security contexts and the DRM/CAS software on an STP provided in the device in advance.

### BRIEF DESCRIPTION OF THE DRAWINGS

The above and other aspects, features, and advantages of the present invention will be more apparent from the following detailed description taken in conjunction with the accompanying drawings, in which:

FIG. 1 illustrates a process for downloading and installing DRM/CAS software according to the conventional art;

FIG. 2 illustrates a configuration of a DRM/CAS service device using DRM/CAS security contexts according to an embodiment of the present invention;

FIG. 3 illustrates a process for generating and downloading DRM/CAS security contexts among a device and DRM/CAS service servers according to an embodiment of the present invention;

FIG. 4 is a diagram illustrating a logical structure configuration of a DRM/CAS security context according to the embodiment of the present invention;

FIG. 5 illustrates a configuration of a STP in a device according to an embodiment of the present invention;

FIG. 6 illustrates a configuration of a security interpreter and a DRM/CAS security context storage unit according to an embodiment of the present invention;

FIG. 7 is a flowchart illustrating an operation of a DRM/CAS SW loader at the time of installing DRM/CAS SW and DRM/CAS security contexts according to an embodiment of the present invention;

FIG. 8 is a flowchart illustrating a process for loading a DRM/CAS SW of a DRM/CAS SW loader according to an embodiment of the present invention;

FIG. 9 is a flowchart illustrating a process for executing an instruction code of a DRM/CAS SW in the interpreter according to an embodiment of the present invention; and

FIG. 10 is a flow diagram illustrating a method for consuming a secure content using DRM/CAS security contexts according to the embodiment of the present invention.

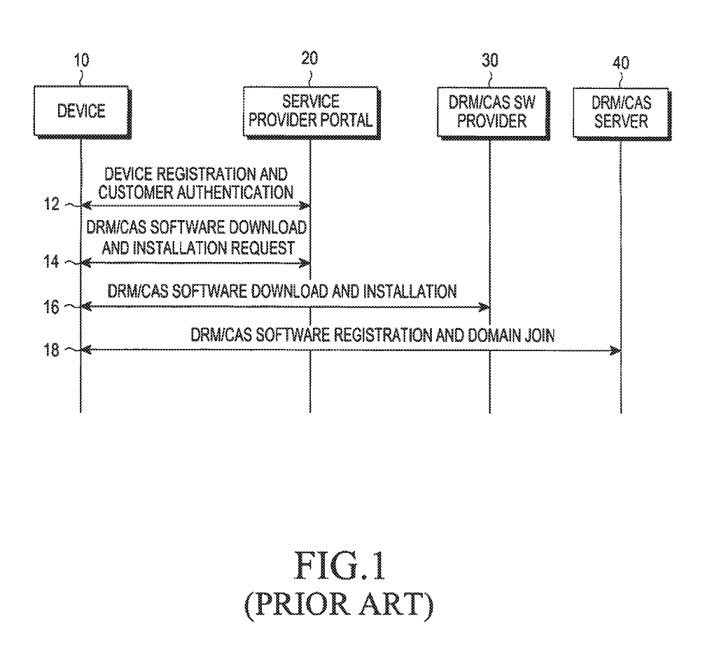

### DETAILED DESCRIPTION OF EMBODIMENTS OF THE PRESENT INVENTION

Hereinafter, various embodiments of the present invention will be described with reference to the accompanying drawings. Further, various specific definitions found in the following description are provided only to help with a general understanding of the present invention, and it is apparent to those skilled in the art that various changes in form and details may be made therein without departing from the spirit and scope of the present invention as defined by the appended claims. Further, in the following description of the present invention, a detailed description of known functions and configurations incorporated herein will be omitted when it may make the subject matter of the present invention unclear.

The present invention describes a configuration in which if DRM/CAS service servers, which provide a content and service protection service (hereinafter referred to as a “DRM/CAS service”) required for receiving the content and service (hereinafter referred to as a “secure content”) to which content and service protection technologies, for example, a DRM (Digital Rights Management) technology and/or a CAS (Conditional Access System) technology are applied, generate DRM/CAS security contexts (DRM/CAS security contexts), generate a DRM/CAS software (SW) package (hereinafter referred to as a ‘DRM/CAS SW package’) embedding DRM/CAS security contexts and DRM/CAS software, and provide the DRM/CAS software package, the device receives the DRM/CAS SW package, acquires and processes the license with respect to the secure content using the DRM/CAS security contexts, and consumes (for example, reproduces and outputs) the secure content.

In the present invention, a DRM/CAS security context includes security information for forming a security connection among a device and DRM/CAS service servers. The security information includes identifiers of communication parties such as devices and DRM/CAS service servers, public or secret credentials of the devices and the servers of DRM/CAS service providers, domain information (for example, domain ID and expiration time), and other meta data such as selection of the encryption algorithm used for the security communication. The present invention reduces a processing amount and simplifies the process by performing content and service protection using DRM/CAS security contexts rather than a license of the content and service being acquired and processed using conventional DRM/CAS software.

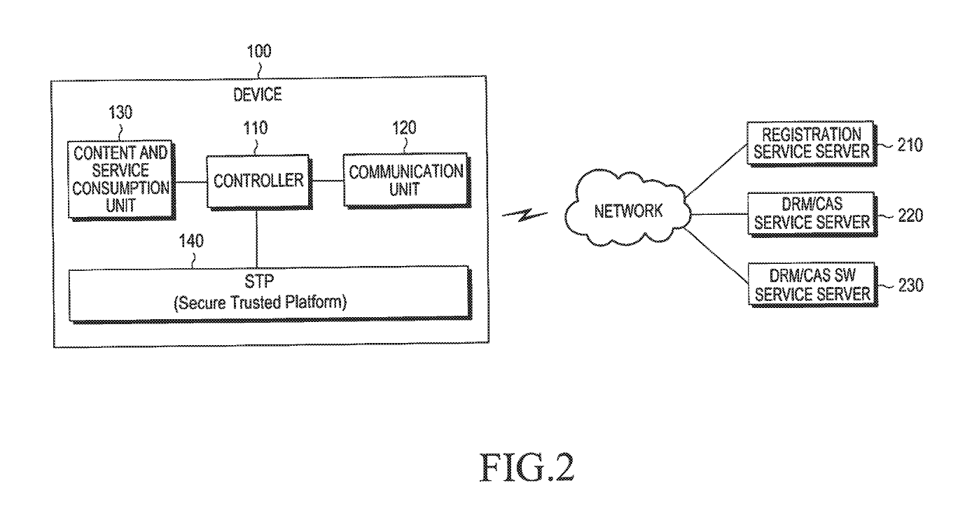

Hereinbelow, a description will be made of specific configurations for achieving the present invention described above. FIG. 2 illustrates a configuration of a DRM/CAS service device using DRM/CAS security contexts according to an embodiment of the present invention. With reference to FIG. 2, the DRM/CAS service device using DRM/CAS security contexts includes a device 100 and DRM/CAS service servers such as a registration service server 210, a DRM/CAS service server 220, and a DRM/CAS SW service server 230.

The device 100 may be a user device such as a television, a desktop computer, a laptop computer, a tablet PC, an MPEG-3 (MP3) audio player, a DVD player, a Blue-ray player, a smart phone, and other portable devices which may consume (reproduce or output) a content/service. The device 100 includes a controller 110, a communication unit 120, the content and service consumption unit 130, and a Secure Trusted Platform (hereinafter referred to as an “STP”) 140.

The controller 110 communicates with DRM/CAS service servers 210, 220, and 230 via a network using the communication unit 120, requests a registration from the registration server 210 when a DRM/CAS service is required, and requests a DRM/CAS service. At this point, the case in which a DRM/CAS service is required refers to, for example, a case that a DRM/CAS software package required for consuming a secure content through the content and service consumption unit 130 is provided (downloaded) and applied.

The STP 140 is a platform that is capable of setting remote authority of the DRM/CAS SW client operated by a DRM/CAS SW in a DRM/CAS SW package, that is trusted for storing and executing the DRM/CAS SW client, and that includes a safe storage space to which DRM/CAS security contexts are installed according to an embodiment of the present invention. The controller 110 transmits the downloaded DRM/CAS SW package to the STP 140 so that the DRM/CAS SW package is stored and un-packed by the STP 140 and performs control so that a DRM/CAS SW client can be operated in the device 100 by using the DRM/CAS security contexts and the DRM/CAS SW embedded in the DRM/CAS SW package.

The registration service server 210 performs a registration service. That is, according to a request from the device 100 for a registration and a DRM/CAS service, it is requested to generate DRM/CAS security contexts by authenticating the device 100 and the STP 140 of the device 100, generating a device-based context, and transmitting a device-based context to the DRM/CAS service server 220. At this point, the STP 140 may be authenticated by using public credentials and shared keys, and the registration service server 210 stores public credentials and public keys of the STP 140 as a result of the authentication. The device-based context may include device ID information, private credentials including user (customer) keys, public credentials including public keys, and customer-related certificates. Meanwhile, the registration request from the device 100 may be made since the registration is requested by the user of the device 100. In this case, the user purchases the device 100 and requests a registration of the device 100 from the registration service server 210 using an account of the user. At this point, the registration service server 210 is a registration service server of a provider of the content and service.

The DRM/CAS service server 220 manages a DRM/CAS domain, sets a content license, and provides a DRM service and a CAS service. For example, the DRM/CAS service server 220 may include a device for issuing a OMA (Open Mobile Alliance) DRM copy right. The DRM/CAS service server 220 generates DRM/CAS security contexts according to a request for generating the DRM/CAS security contexts from the registration service server 210. At this point, the DRM/CAS security contexts may include a client security context, a server security context, and a shared security context. The client security context may be generated by using the device-based context, and may include information for security of the DRM/CAS SW client to be executed by the STP 140 of the device 100. The server security context may include information for security in communication with the DRM/CAS service servers 210, 220, and 230. The shared security context may include security information shared among the DRM/CAS SW client and the DRM/CAS service servers 210, 220, and 230, and security information shared among multiple devices. The DRM/CAS service server 220 transmits the DRM/CAS security contexts as described above to the DRM/CAS SW service server 230.

The DRM/CAS SW service server 230 provides a DRM SW and/or a CAS SW to be executed in the STP 140, receives DRM/CAS security contexts from the DRM/CAS service server 220, and generates a DRM/CAS SW package embedding the DRM/CAS security contexts. In addition, the DRM/CAS SW service server 230 provides the generated DRM/CAS SW package to be downloaded by the device 100. Accordingly, the device 100 downloads the DRM/CAS SW package and installs the DRM/CAS SW and the DRM/CAS security contexts included in the DRM/CAS SW package so that the DRM/CAS SW client is executed.

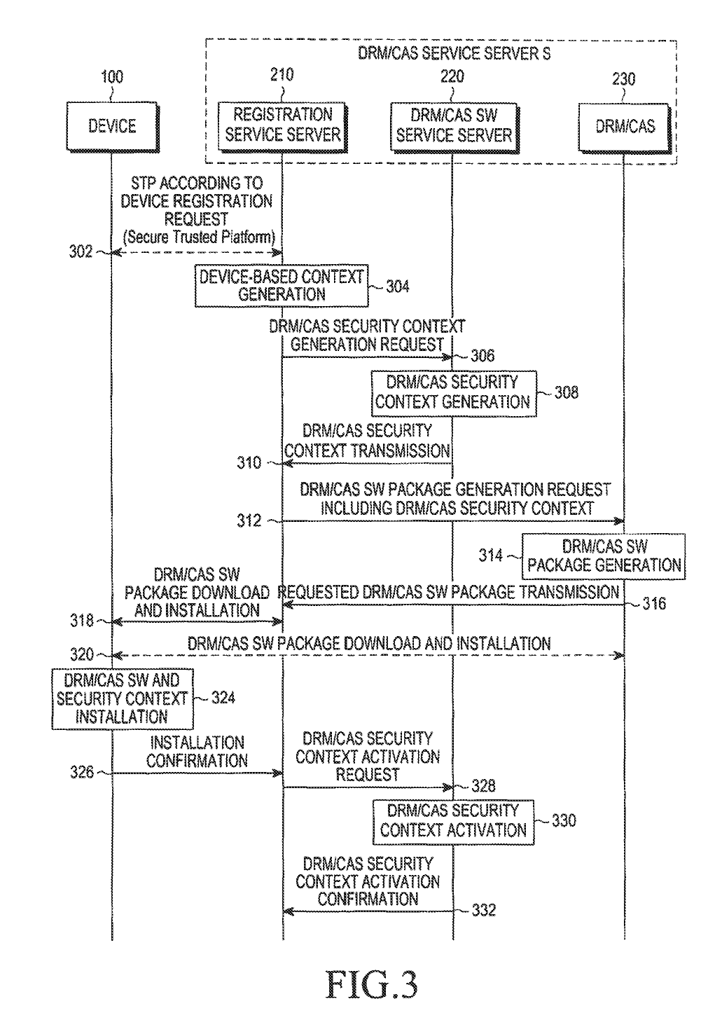

A process for generating DRM/CAS security contexts 300 between the device 100 and the DRM/CAS service servers 210, 220, and 230 configured as described above and a process for receiving and using the generated DRM/CAS security contexts 300 will be described more specifically with reference to FIG. 3.

FIG. 3 illustrates a process for generating and downloading DRM/CAS security contexts among the device 100 and the DRM/CAS service servers 210, 220, and 230 according to an embodiment of the present invention. With reference to FIG. 3, the device 100 may be a user device such as a television, a desktop computer, a laptop computer, a tablet PC, an MPEG-3 (MP3) audio player, a DVD player, a Blue-Ray player, a smart phone, and other portable device which may consume a content/service. In Step 302, the device 100 communicates with the registration service server 210 and authenticates the STP 140 according to the request for device registration, when the device registration for receiving a DRM/CAS service is requested by a user. Specifically, the device 100 requests device registration from the registration service server 210, and requests to provide a DRM/CAS service, when the device registration for receiving the DRM/CAS service by the user is requested. The registration service server 210 authenticates the STP 140 of the device 100 according to the request for the registration and the request for providing the DRM/CAS service from the device 100. At this point, the authentication of the STP 140 may be authenticated by using public credentials and shared keys, and the registration service server 210 may store the public credentials and the public keys of the STP 140 as a result of the authentication.

After authenticating the STP 140 of the device 100, the registration service server 210 generates a device-based context in Step 304. The device-based context may include device ID information, private credentials including user (customer) keys, public credentials including public keys, and customer-related certificates. In particular, the device-based context may include credentials relating to the DRM/CAS SW client to be installed and executed on the STP 140. At this point, the credentials regarding the DRM/CAS SW client may be generated by a dedicated function of a content and service provider (not illustrated), or may be a pair of the public key and the private key provided by a third party. Further, the device-based context may include identification information of domains in which the device participates, if possible.

Using the device-based context generated as described above, the registration service server 210 requests to generate the DRM/CAS security contexts to the DRM/CAS service server 220 in Step 306. The registration service server 210 includes a device-based context in a request message for generating the DRM/CAS security contexts and transmits the request message to the DRM/CAS service server 220 at the time of requesting to generate the DRM/CAS security contexts. Further, the request message for generating the DRM/CAS security contexts may include information necessary for generating a new DRM/CAS domain, and may include a DRM/CAS system set-up profile based on a version or a specification of the DRM/CAS SW. The DRM/CAS system set-up profile may include, for example, instructions for selecting encryption and signature algorithms to be executed on the device 100 after the installation of the DRM/CAS SW client.

In Step 308, the DRM/CAS service server 220 generates DRM/CAS security contexts according to the request for generating the DRM/CAS security contexts. At this point, the DRM/CAS security contexts may include a client security context, a server security context, and a shared security context. The client security context may be generated by using the device-based context, and may include information for security of the DRM/CAS SW client to be operated in the STP 140 of the device 100. The server security context may include information for security in a communication with the DRM/CAS service servers 210, 220, and 230. The shared security context may include security information shared among the DRM/CAS SW client and the DRM/CAS service servers 210, 220, and 230 and security information shared among multiple devices.

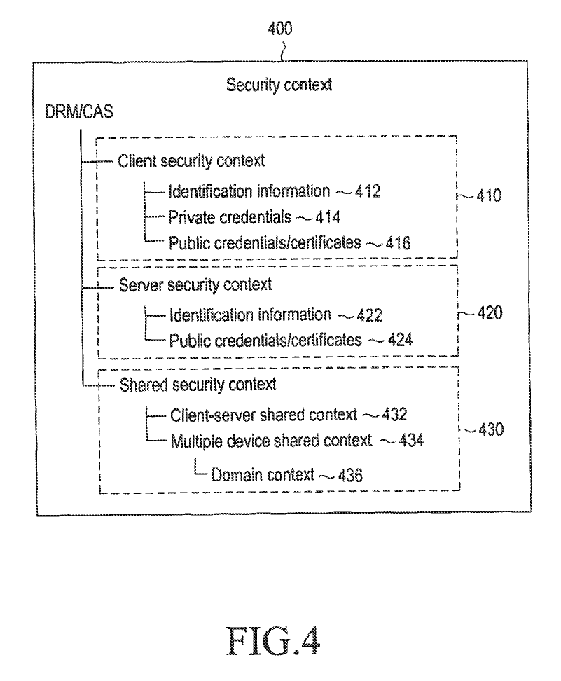

The DRM/CAS security contexts are described more specifically, with reference to FIG. 4, as follows. FIG. 4 is a diagram illustrating a logical structure configuration of the DRM/CAS security contexts 400 according to the embodiment of the present invention. A client security context 410 may be generated by using the device-based context generated by the registration service server 210, and includes identification information 412 of the DRM/CAS SW client to be executed in the STP 140 of the device 100, private credentials 414 including keys shared in advance and PKI (Public Key Infrastructure) private keys, and public credentials and certificates 416 including PKI public keys and related authentication chains. For example, the client security context 410 may be a context with respect to a context for the OMA DRM system and a context for a Marlin DRM system.

The server security context 420 selectively includes identification information 422 of the DRM/CAS service servers 210, 220, and 230, and public credentials and certificates 424 of the DRM/CAS service servers 210, 220, and 230. At this point, the public credentials of the DRM/CAS service servers 210, 220, and 230 may be PKI public key certificates.

The shared security context 430 includes a client-server shared context 432 shared among the DRM/CAS SW client and the DRM/CAS service servers 210, 220, and 230, and a multiple device shared context 434 shared among multiple devices. The client-server shared context 432 includes key elements forming termination security relations among the DRM/CAS SW client and the DRM/CAS service servers 210, 220, and 230 for a special service and relating meta data. The multiple device shared context 434 includes key elements permitting sharing contexts and services among a plurality of devices in the same group or domain or relating meta data. For example, the multiple device shared context 434 may include domain contexts 436, and the domain contexts may be OMA DRM domain contexts or Marlin link objects.

Referring back to FIG. 3, after generating the DRM/CAS security contexts 400 configured as described above, the DRM/CAS service server 220 transmits the DRM/CAS security contexts 400 to the registration service server 210 in Step 310.

In Step 312, the registration service server 210 requests a DRM/CAS SW service so that a DRM/CAS SW package including the DRM/CAS security contexts 400 is generated in the DRM/CAS SW service server 230. At this point, a message for requesting the DRM/CAS SW service from the registration service server 210 to the DRM/CAS SW service server 230 may be transmitted. The message for requesting the DRM/CAS SW service may include the DRM/CAS security contexts 400, and may also include data relating to identification information for requesting the DRM/CAS SW service, version information, and other service requests. In addition, the message for requesting the DRM/CAS SW service may include information for safely installing the DRM/CAS SW client on the STP 140 by the DRM/CAS SW package such as the identification information and/or public credentials of the STP 140.

In Step 314, the DRM/CAS SW service server 230 generates and stores the DRM/CAS SW package according to the request for generating the DRM/CAS SW package. Specifically, the DRM/CAS SW service server 230 generates and stores a DRM/CAS SW package embedding DRM/CAS security contexts using the DRM SW and/or CAS SW executed in the STP 140 and the DRM/CAS security contexts received from the registration service server 210.

In addition, the DRM/CAS SW service server 230 transmits the DRM/CAS SW package to the registration service server 210 in Step 316. Accordingly, the registration service server 210 provides the DRM/CAS SW package to the device 100 in Step 318. That is, the registration service server 210 downloads the DRM/CAS SW package to the device 100.

Meanwhile, in Steps 316 and 318, the DRM/CAS SW service server 230 transmits the DRM/CAS SW package to the registration service server 210, and the registration service server 210 downloads the DRM/CAS SW package to the device 100. However, according to another embodiment of the present invention, the DRM/CAS SW service server 230 may provide the DRM/CAS SW package directly to the device 100. In this case, the DRM/CAS SW service server 230 generates and stores the DRM/CAS SW package, confirms the generation and storage, and waits for a request for downloading the DRM/CAS SW package from the device 100. In addition, if the DRM/CAS SW service server 230 receives a request for downloading the DRM/CAS SW package from the device 100, the DRM/CAS SW service server 230 downloads the DRM/CAS SW package to the device 100 in Step 320. At this point, it is desired that the device 100 receives information required for connection to the DRM/CAS SW service server 230 from the registration service server 210 and for downloading (for example, access credentials and URL (Uniform Resource Locator) in order to request to download the DRM/CAS SW package from the DRM/CAS SW service server 230 and to perform downloading from the DRM/CAS SW service server 230.

After downloading the DRM/CAS SW package, the device 100 installs the DRM/CAS SW and the DRM/CAS security contexts embedded in the DRM/CAS SW package in Step 324. At this point, it is desirable that the device 100 installs the DRM/CAS SW in advance, authenticates the DRM/CAS SW, and then installs the DRM/CAS security contexts when the DRM/CAS SW is authenticated. At this point, the configuration of the device 100 for installing the DRM/CAS security contexts will be described below in detail.

When the DRM/CAS SW and the DRM/CAS security contexts are installed, the device 100 confirms the installation of the DRM/CAS SW and the DRM/CAS security contexts to the registration service server 210 in Step 326. At this point, the device 100 may transmit a message for confirming the installation of the DRM/CAS SW and the DRM/CAS security contexts to the registration service server 210. The message for confirming the installation of the DRM/CAS SW and the DRM/CAS security contexts may include security information generated when the DRM/CAS SW and the DRM/CAS security contexts are successfully installed on the device 100.

When the installation of the DRM/CAS SW and the DRM/CAS security contexts are confirmed by the device 100, the registration service server 210 confirms the installation of the DRM/CAS SW and the DRM/CAS security contexts to the DRM/CAS service server 220 in Step 328, and requests to activate the DRM/CAS security contexts. At this point, the registration service server 210 may confirm the installation of the DRM/CAS SW and the DRM/CAS security contexts by transmitting, to the DRM/CAS service server 220, security information generated when DRM/CAS SW and the DRM/CAS security contexts are successfully installed on the device 100.

Accordingly, in Step 330, the DRM/CAS service server 220 authenticates the installation of the DRM/CAS SW and the DRM/CAS security contexts and activates the corresponding DRM/CAS security contexts. In addition, the DRM/CAS service server 220 confirms the activation of DRM/CAS security contexts to the registration service server 210 in Step 330. Accordingly, the device 100 operates as a DRM/CAS client using the DRM/CAS SW and the DRM/CAS security contexts installed on the STP 140 so as to receive a secure content service.

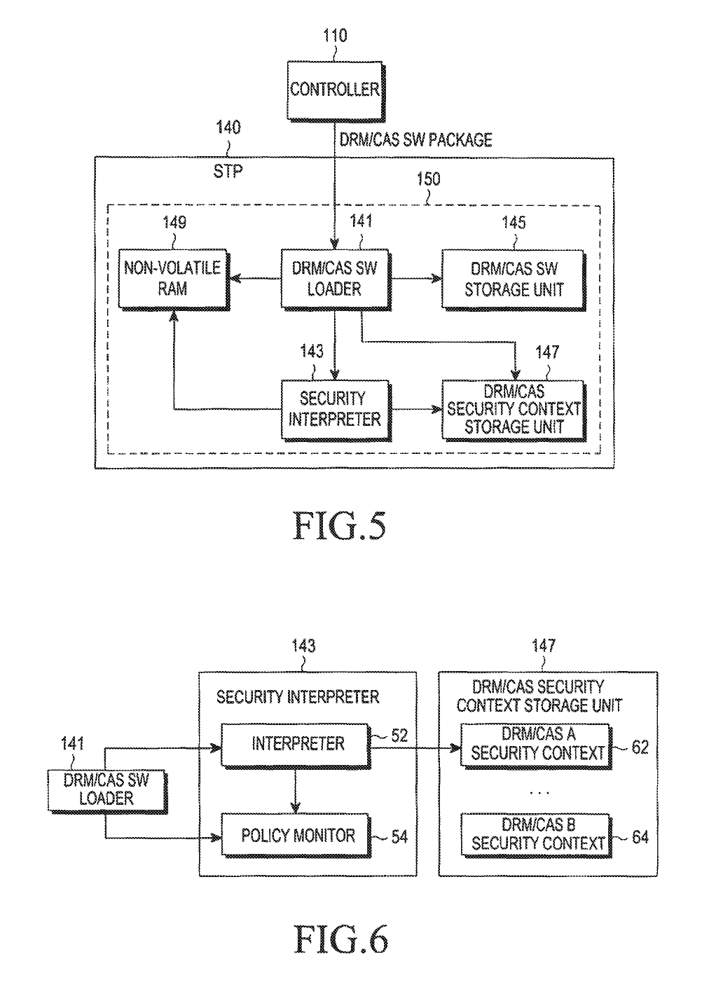

A process for generating and using the DRM/CAS security contexts among the device 100 and the DRM/CAS service servers 210, 220, and 230 according to the embodiment of the present invention has been described above. A configuration for installing the DRM/CAS SW and the DRM/CAS security contexts embedded in the DRM/CAS SW package when the device 100 receives the DRM/CAS SW package from the DRM/CAS service servers 210, 220, and 230 will be described in more detail with reference to FIG. 5, as follows.

FIG. 5 illustrates a configuration of an STP 140 in a device 100 for installing a DRM/CAS SW and DRM/CAS security contexts embedded in a DRM/CAS SW package according to an embodiment of the present invention.

The STP 140 operates as a DRM/CAS client 150 by installing the DRM/CAS SW and the DRM/CAS security contexts included in the DRM/CAS SW package. The STP 140 includes a DRM/CAS SW loader 141, a security interpreter 143, a DRM/CAS SW storage unit 145, a DRM/CAS security context storage unit 147, and a non-volatile RAM 149.

The DRM/CAS SW loader 141 receives the DRM/CAS SW package from the controller 110, and confirms integrity and authentication of the input DRM/CAS SW package. In addition, the DRM/CAS SW loader 141 un-packs the DRM/CAS SW package. The DRM/CAS SW loader 141 also stores the DRM/CAS SW included in the DRM/CAS SW package in the DRM/CAS SW storage unit 145, and stores the DRM/CAS security contexts embedded in the DRM/CAS SW package in the DRM/CAS security context storage unit 147. In addition, at the time of code execution of the DRM/CAS SW, the DRM/CAS SW loader 141 loads the DRM/CAS SW on the security interpreter 143 so that the DRM/CAS SW code is executed. As the DRM/CAS SW code is executed, variables and other data are stored in the non-volatile RAM 149 while a DRM/CAS SW client 150 is in operation.

The security interpreter 143 executes a DRM/CAS SW code input through the DRM/CAS SW loader 141. The security interpreter 143 executes the DRM/CAS SW code using the permitted DRM/CAS security contexts of the DRM/CAS security context storage unit 147 and the data of the non-volatile RAM 149 according to whether a connection of the DRM/CAS SW to the DRM/CAS security contexts stored in the DRM/CAS security context storage unit 147 is permitted.

The DRM/CAS SW storage unit 145 is a general purpose secure storage, and stores the DRM/CAS SW code by the DRM/CAS SW loader 141. That is, the DRM/CAS SW storage unit 145 is used as a directory for installing the DRM/CAS SW.

The DRM/CAS security context storage unit 147 is a storage to which access is limited, so that access by the permitted DRM/CAS SW is possible. The DRM/CAS security context storage unit 147 stores the DRM/CAS security contexts by the DRM/CAS SW loader 141. For example, the DRM/CAS security context storage unit 147 is used for storing data that requires high security such as device keys and domain keys.

When the DRM/CAS SW code is executed, the non-volatile RAM 149 stores variables and other data while the DRM/CAS SW client 150 is in operation. The non-volatile RAM 149 may include pointers indicating locations in the DRM/CAS security context storage unit 147 with respect to the DRM/CAS security contexts loaded in advance by the DRM/CAS SW loader 141.

With reference to FIG. 6, a description will be made of a configuration of the security interpreter 143 and the DRM/CAS security context storage unit 147 described as above. FIG. 6 illustrates a specific configuration of the security interpreter 143 and the DRM/CAS security context storage unit 147 according to an embodiment of the present invention. With reference to FIG. 6, the security interpreter 143 includes an interpreter 52 and a policy monitor 54, and the DRM/CAS security context storage unit 147 stores one or more DRM/CAS security contexts such as a DRM/CAS A security context 62 and a DRM/CAS B security context 64.

In this case, the policy monitor 54 includes available DRM/CAS security context information and lists of pointers with respect to the locations of the one or more DRM/CAS security contexts in the DRM/CAS security context storage unit 147. In addition, the policy monitor 54 is used for determining whether connections of the DRM/CAS security contexts to each of the DRM/CAS SWs which are loaded on the interpreter 52 by the DRM/CAS SW loader 141 and stored in the DRM/CAS security context storage unit 147 are permitted or not. For example, a DRM/CAS A security context with respect to one DRM/CAS system (DRM/CAS A) should not be connected to another DRM/CAS system (DRM/CAS B). This connection may be controlled by the policy monitor 54.

A description will be made to a process for operating the DRM/CAS SW loader 141 and the security interpreter 143 at the time of installing and using the DRM/CAS SW and the DRM/CAS security contexts in the STP 140 configured as described above.

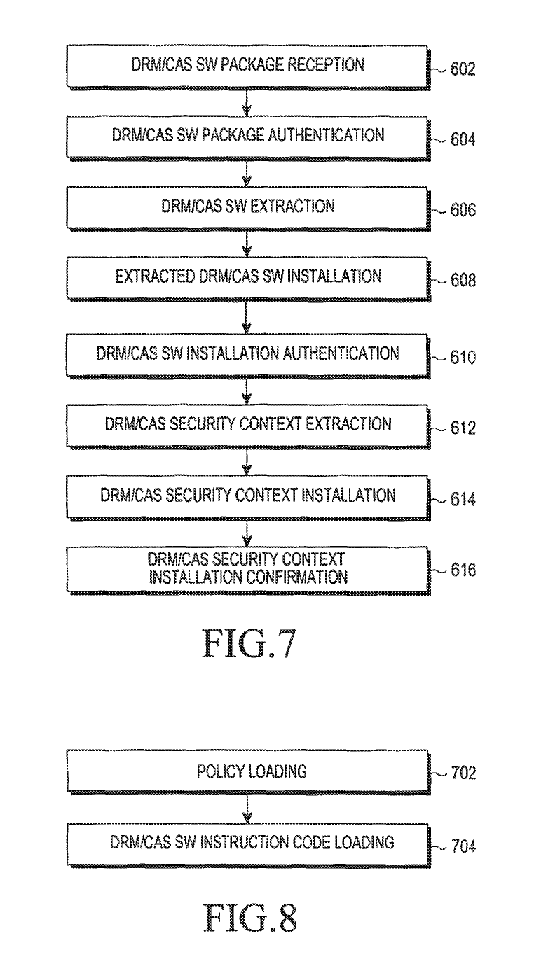

First, with reference to FIG. 7, a description is made of an operation of the DRM/CAS SW loader 141 when the DRM/CAS SW and the DRM/CAS security contexts are installed in the STP 140. FIG. 7 is a flowchart illustrating an operation of the DRM/CAS SW loader 141 at the time of installing the DRM/CAS SW and the DRM/CAS security contexts according to an embodiment of the present invention.

The DRM/CAS SW loader 141 receives the DRM/CAS SW package from the controller 110 in Step 602, and authenticates the DRM/CAS SW in Step 604.

Further, the DRM/CAS SW loader 141 un-packs the DRM/CAS SW package in Step 606, extracts a DRM/CAS SW, and installs the extracted DRM/CAS SW in Step 608. At this point, the installed DRM/CAS SW may be stored in the DRM/CAS SW storage unit 145.

After installing the DRM/CAS SW, the DRM/CAS SW loader 141 safely authenticates the installation of the DRM/CAS SW in Step 610. Further, the DRM/CAS SW loader 141 safely authenticates installation of software. In addition, the DRM/CAS SW loader 141 extracts DRM/CAS security contexts from the DRM/CAS SW package in Step 612, and installs (stores) the DRM/CAS security contexts in the DRM/CAS security context storage unit 147 in Step 614. At this point, the DRM/CAS SW loader 141 may store (record) pointers with respect to the locations of the DRM/CAS security contexts on the non-volatile RAM 149 and/or the policy monitor 54.

After installing the DRM/CAS security contexts, the DRM/CAS SW loader 141 confirms the installation of the DRM/CAS SW to the controller 110 in Step 616. Accordingly, the controller 110 of the device 100 recognizes that the DRM/CAS SW and the DRM/CAS security contexts are installed in the device 100.

When the DRM/CAS SW is installed by the DRM/CAS SW loader 141 as described above, the DRM/CAS SW loader 141 loads the DRM/CAS SW on the security interpreter 143 for executing the DRM/CAS SW.

FIG. 8 is a flowchart illustrating a process for loading a DRM/CAS SW of a DRM/CAS SW loader 141 according to an embodiment of the present invention. With reference to FIG. 8, the DRM/CAS SW loader 141 extracts a connection policy of the DRM/CAS SW in Step 702 and loads the extracted connection policy on the policy monitor 54 before the execution of the DRM/CAS SW. In addition, in Step 704, the DRM/CAS SW loader 141 loads an instruction code of the DRM/CAS SW on the interpreter 52 and the non-volatile RAM 149 so that the DRM/CAS SW may be executed.

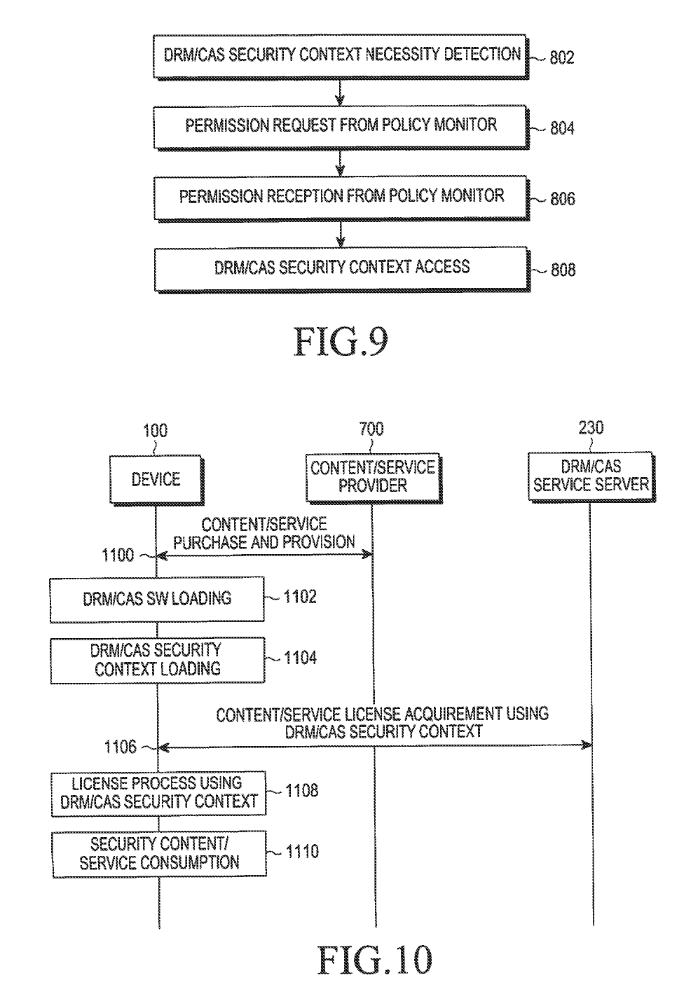

FIG. 9 is a flowchart illustrating a process for executing an instruction code of a DRM/CAS SW in the interpreter 52 according to an embodiment of the present invention. With reference to FIG. 9, the interpreter 52 determines whether the DRM/CAS security contexts for executing the instruction code of the DRM/CAS SW in Step 802 are required or not. For example, if a domain key is required for a domain license process, the interpreter 52 may determine that the DRM/CAS security contexts including domain keys are required.

If the DRM/CAS security contexts are required, the interpreter 52 requests access permission of the DRM/CAS security contexts from the policy monitor 54 in Step 804. At this point, the request for the access permission may include descriptions with respect to the DRM/CAS security contexts such as information on an event for obtaining the DRM/CAS security contexts or DRM/CAS security context identification information (for example, required domain key information extracted from the domain license).

If permission for an access to DRM/CAS security contexts by the policy monitor 54 is successfully performed, the interpreter 52 receives the permission from the policy monitor 54 in Step 806. At this point, the permission from the policy monitor 54 includes pointers with respect to locations of the DRM/CAS security contexts in the DRM/CAS security context storage unit 147 recorded on the non-volatile RAM 149.

In Step 808, the interpreter 52 connects to the DRM/CAS security contexts using pointers with respect to the locations of the DRM/CAS security contexts in the DRM/CAS security context storage unit 147 and related meta data, and uses the corresponding DRM/CAS security contexts so that the DRM/CAS SW can be executed.

If the DRM/CAS security contexts and the DRM/CAS SW are installed on the device 100 as described above, the device 100 may consume the secure content using the DRM/CAS security contexts.

FIG. 10 is a flow diagram illustrating a method for consuming the secure content using the DRM/CAS security contexts according to the embodiment of the present invention. With reference to FIG. 10, in Step 1100, the device 100 performs browsing for receiving a content and service from a content/service provider 700 providing the content and service according to a request from a user and performs payment for the selected content or service among a plurality of contents and services from the user. In addition, if the payment is completed, the device 100 is instructed from the content/service provider 700 to acquire a license (right) required for consuming (reproducing or outputting) the selected content or service.

Accordingly, the device 100 installs the DRM/CAS SW and the DRM/CAS security contexts, and loads the DRM/CAS SW in Step 1102. At this point, the device 100 may directly proceed to Step 1102, if the DRM/CAS security contexts and the DRM/CAS SW have been installed.

After loading the DRM/CAS SW, the device 100 loads the DRM/CAS security contexts in Step 1104. At this point, the device 100 may load a client security context 410 and a server security context 420 among the DRM/CAS security contexts as illustrated in FIG. 4. Meanwhile, the device 100 may load a client-server shared context 432, if necessary.

In this manner, if the DRM/CAS SW and the DRM/CAS security contexts are loaded, a DRM/CAS client operates in the device 100. In Step 1106, a license (right) required for consuming the content or service from the DRM/CAS service server 230 using the DRM/CAS security contexts 400 through the DRM/CAS client of the device 100 is acquired. At this point, acquiring the license requires the DRM/CAS security contexts 400. Especially, when the license is associated with multiple devices, the multiple device shared context 434 may be used for acquiring the license.

If the license (right) required for consuming the content or service is acquired, the device 100 processes the license using the DRM/CAS security contexts 400 in Step 1108. As a result, the device 100 consumes the content or service through the content and service consumption unit 130 in Step 1110. For example, the device 100 reproduces or outputs the content or service.

The present invention reduces the amount of processes and simplifies the method of processing by installing and using the DRM/CAS SW using the DRM/CAS security contexts 400. Further, the present invention provides an effect of more effectively performing content and service protection by receiving the DRM/CAS SW package embedding the DRM/CAS security contexts 300 by the device 100 having a secure trusted platform (STP) and by acquiring and processing the license of the content and service using the DRM/CAS security contexts 400.

Although specific embodiments of the present invention have been described above, it is obvious that various modifications are possible, without departing from the scope of the invention. Therefore, the scope of the present invention is not limited by the embodiments, but the scope of the present invention shall be construed on the basis of the accompanying claims in such a manner that all of the technical ideas included within the scope equivalent to the claims belong to the present invention.

What is claimed is:

1. A Digital Rights Management/Conditional Access System (DRM/CAS) service device comprising:
a registration service server that authenticates a device and a Secure Trusted Platform (STP) of the device and generates a device-based context according to a registration request and a DRM/CAS service request from the device;
a DRM/CAS service server that receives the device-based context and generates DRM/CAS security contexts; and
a DRM/CAS software (SW) service server that receives the DRM/CAS security contexts, generates a DRM/CAS software package including the DRM/CAS security contexts and DRM/CAS software, and enables the DRM/CAS software package to be provided for the device.

2. The DRM/CAS service device according to claim 1, wherein the device-based context comprises device ID information, private credentials including user (customer) keys, public credentials including public keys, and customer-related certificates.

3. The DRM/CAS service device according to claim 2, wherein the DRM/CAS security contexts comprises:
a client security context that is generated using the device-based context and includes information for security of a DRM/CAS software client to be operated in the STP of the device; and
a server security context that includes information for security in communication with the DRM/CAS service servers.

4. The DRM/CAS service device according to claim 3, further comprising:
a shared security context that comprises security information shared among the DRM/CAS software client and the DRM/CAS service servers and security information shared among multiple devices.

5. A DRM/CAS service method comprising:
authenticating a device and an STP of the device and generating a device-based context according to a registration request and a DRM/CAS service request from the device;
receiving the device-based context and generating DRM/CAS security contexts;
receiving the DRM/CAS security contexts and generating a DRM/CAS software package including the DRM/CAS security contexts and DRM/CAS software, and
providing the DRM/CAS software package for the device.

6. The DRM/CAS service method according to claim 5, wherein the device-based context comprises device ID information, private credentials including user (customer) keys, public credentials including public keys, and customer-related certificates.

7. The DRM/CAS service method according to claim 6, wherein the DRM/CAS security contexts comprises:
a client security context that is generated using the device-based context and includes information for security of a DRM/CAS software client to be operated in the STP of the device; and
a server security context that includes information for security in communication with the DRM/CAS service servers.

8. The DRM/CAS service method according to claim 7, further comprising:
a shared security context that comprises security information shared among the DRM/CAS software client and the DRM/CAS service servers and security information shared among multiple devices.

9. A device comprising:
a communication unit that communicates with servers for receiving a DRM/CAS service;
an STP that stores software and data for the DRM/CAS service; and
a controller that performs a request for the DRM/CAS service by communicating with the servers for receiving the DRM/CAS service, receives a DRM/CAS software package having embedded DRM/CAS security contexts and DRM/CAS software according to the request for the DRM/CAS service; and stores and installs the DRM/CAS security contexts and the DRM/CAS software on the STP.

10. The device according to claim 9, wherein the STP comprises:
a DRM/CAS software storage unit that stores the DRM/CAS software included in the DRM/CAS software package;
a DRM/CAS security context storage unit that stores the DRM/CAS security contexts included in the DRM/CAS software package;
a non-volatile RAM that stores variables and other data while a DRM/CAS software client by an execution of the DRM/CAS software is in operation;
a DRM/CAS software loader that receives the DRM/CAS software package from the controller, confirms integrity and authentication of the received DRM/CAS software package, un-packs the DRM/CAS software package, stores the DRM/CAS software package on the DRM/CAS software storage unit, stores the DRM/CAS security contexts on the DRM/CAS security context storage unit, and loads a code of the DRM/CAS software for executing the DRM/CAS software on a security interpreter; and
the security interpreter that executes the DRM/CAS software when the code of the DRM/CAS software is loaded.

11. The device according to claim 10, wherein the security interpreter comprises a policy monitor that stores whether or not a connection of the DRM/CAS software to the DRM/CAS security contexts stored in the DRM/CAS security context storage unit is permitted, and
wherein the security interpreter executes the DRM/CAS software using the DRM/CAS security contexts permitted by the policy monitor and the data of the non-volatile RAM.

12. The device according to claim 10, wherein the DRM/CAS security contexts comprises:
a client security context that includes information for security of the DRM/CAS software client to be operated in the STP of the device; and
a server security context that includes information for security in communication with the DRM/CAS service servers.

13. The device according to claim 12, further comprising a shared security context that comprises security information shared between the DRM/CAS software client and the DRM/CAS service servers and security information shared among multiple devices.

14. A DRM/CAS service method in a device comprising:
performing a request for DRM/CAS service by communicating with servers for receiving the DRM/CAS service;
receiving a DRM/CAS software package having embedded DRM/CAS security contexts and DRM/CAS software according to the request for the DRM/CAS service; and
storing and installing the DRM/CAS security contexts and the DRM/CAS software on an STP provided in the device in advance.

15. The DRM/CAS service method in a device according to claim 14, wherein the DRM/CAS security contexts comprises:
a client security context that includes information for security of a DRM/CAS software client to be operated in the STP of the device; and
a server security context that includes information for security in communication with the DRM/CAS service servers.

16. The DRM/CAS service method in a device according to claim 14, further comprising a shared security context that comprises security information shared among a DRM/CAS software client and the DRM/CAS service servers and security information shared among multiple devices.

17. The DRM/CAS service method in a device according to claim 14, further comprising:
requesting a content and service from a content/service provider providing the content and service according to a request from a user, and performing a payment for a selected content or service among a plurality of contents and services by the user;
receiving an instruction to acquire a license (right) required for consuming the selected content or service from contents of the content/service provider;
acquiring the license by loading the DRM/CAS software and the DRM/CAS security contexts installed in advance according to the instruction; and
processing the license using the DRM/CAS security contexts and consuming the content or service according to a result of processing the license.
